(19) United States
(12) Patent Application Publication
(10) Pub. No.: US 2024/0013668 A1
(43) Pub. Date: Jan. 11, 2024

(54) Information Processing Method, Program, And Information Processing Apparatus

(71) Applicant: ONGLI INC., Tokyo (JP)

(72) Inventors: Hiroyuki KUNII, Tokyo (JP); Hiroto KAINO, Tokyo (JP)

(21) Appl. No.: 18/324,237

(22) Filed: May 26, 2023

(30) Foreign Application Priority Data
Jul. 7, 2022 (JP) 2022-109935

(51) Int. Cl. G09B 5/06; G10L 13/02; G10L 15/08; G10L 15/22; G09B 19/00

(52) U.S. Cl. CPC G09B 5/06; G10L 13/02; G10L 15/08; G10L 15/22; G09B 19/00

(57) ABSTRACT

An information processing method includes a reading step, an acquisition step, a conversion step, a determination step, and a display control step. In the reading step, first character information on a character of a teaching material is read. In the acquisition step, a read-aloud sound relating to a first user's voice when the first user reads aloud the first character information is acquired. In the conversion step, the read-aloud sound is converted into second character information on a character. In the determination step, based on the first character information and the second character information, a matching point between the first character information and the second character information is determined. In the display control step, when there is the matching point, the matching point is displayed in the first character information in a different display manner from a display manner of the first character information.

### CROSS REFERENCE TO RELATED APPLICATIONS

The present application claims priority under 35 U.S.C. § 119 to Japanese Patent Application No. 2022-109935, filed on Jul. 7, 2022, which is expressly incorporated by reference herein in its entirety.

### BACKGROUND

### Technical Field

The present disclosure relates to an information processing method, a program, and an information processing apparatus.

### Related Art

Japanese Patent Application Laid-Open No. 2016-157042 discloses the following technique.

An electronic apparatus includes a text display unit configured to display text on a display, a voice recognition unit configured to recognize a content of a voice uttered by a user, a misreading part display unit configured to compare the content of the user's voice recognized by the voice recognition unit and a content of the text and to allow, when there is a misread part, the misread part in the text to be displayed distinguishably from the other part of the text, and a rereading instruction unit configured to instruct the user to reread the text.

However, the main application of the above-described technique is use in learning, and therefore it is difficult for the above-application to provide an experience of fun of reading aloud.

In view of the above circumstances, an aspect of the present disclosure provides an information processing apparatus capable of providing an experience of the fun of reading aloud.

According to an aspect of the present disclosure, an information processing method is provided. This information processing method includes a reading step, an acquisition step, a conversion step, a determination step, and a display control step. In the reading step, first character information on a character of a teaching material is read. In the acquisition step, a read-aloud sound relating to a first user's voice when the first user reads aloud the first character information is acquired. In the conversion step, the read-aloud sound is converted into second character information on a character. In the determination step, based on the first character information and the second character information, a matching point between the first character information and the second character information is determined. In the display control step, the matching point is displayed in the first character information in a different display manner from a display manner of the first character information.

According to the above disclosure, it is possible to provide an experience of the fun of reading aloud.

### BRIEF DESCRIPTION OF DRAWINGS

FIG. 1 is a configuration diagram illustrating an information processing system 100.

FIG. 2 is a block diagram illustrating a hardware configuration of a server apparatus 200.

FIG. 3 is a block diagram illustrating a hardware configuration of an information processing apparatus 300.

FIG. 4 is a block diagram illustrating functions realized by the information processing apparatus 300 (controller 310).

FIG. 5 is an activity diagram illustrating a flow of information processing executed by the information processing apparatus 300.

FIG. 6 is an activity diagram illustrating a flow of information processing executed by the information processing apparatus 300.

FIG. 7 is an activity diagram illustrating a flow of information processing executed by the information processing apparatus 300.

FIG. 8 illustrates an example of a menu screen.

FIG. 9 illustrates an example of a listening start screen.

FIG. 10 illustrates an example of a screen during listening.

FIG. 11 illustrates an example of a speaking start screen.

FIG. 12 illustrates an example of a screen during speaking.

FIG. 13 illustrates an example of a screen displaying history.

FIG. 14 illustrates an example of a teaching material creation screen.

FIG. 15 illustrates an example of a teaching material edit screen.

FIG. 16 illustrates an example of a message check screen.

FIG. 17 illustrates an example of a message input screen.

FIG. 18 illustrates an example of a menu screen.

FIG. 19 illustrates an example of a class addition screen.

FIG. 20 illustrates an example of a student addition screen.

FIG. 21 illustrates an example of a student detail display screen.

FIG. 22 illustrates an example of a schedule management screen.

FIG. 23 illustrates an example of a display screen for the first teaching material information.

FIG. 24 illustrates an example of a screen for reading a teaching material.

FIG. 25 illustrates an example of a setting screen for a teaching material delivery.

### DETAILED DESCRIPTION

Hereinafter, a description will be given of embodiments of the present disclosure with reference to drawings. Various features described in the following embodiment can be combined with each other.

A program for realizing a software described in the present embodiment may be provided as a computer-readable non-transitory memory medium, may be provided to be downloaded via an external server, or may be provided so that the program is activated on an external computer and the program's function is realized on a client terminal (that is, the function is provided by so-called cloud computing).

A term “unit” in the present embodiment may include, for example, a combination of a hardware resource implemented as circuits in a broad sense and information processing of software that can be concretely realized by the hardware resource. Furthermore, various types of information are described in the present embodiment, and such information may be represented by, for example, physical values of signal values representing voltage and current, high and low signal values as a set of binary bits consisting of 0 or 1, or quantum superposition (so-called qubits), and communication and computation may be executed on a circuit in a broad sense.

The circuit in a broad sense is a circuit realized by properly combining at least a circuit, circuitry, a processor, a memory, and the like. In other words, a circuit includes an application specific integrated circuit (ASIC), a programmable logic device (e.g., simple programmable logic device (SPLD), a complex programmable logic device (CLPD), field programmable gate array (FPGA), and the like.

### 1. Hardware Configuration

Section 1 describes the hardware configuration according to the present embodiment.

### 1-1. Information Processing System 100

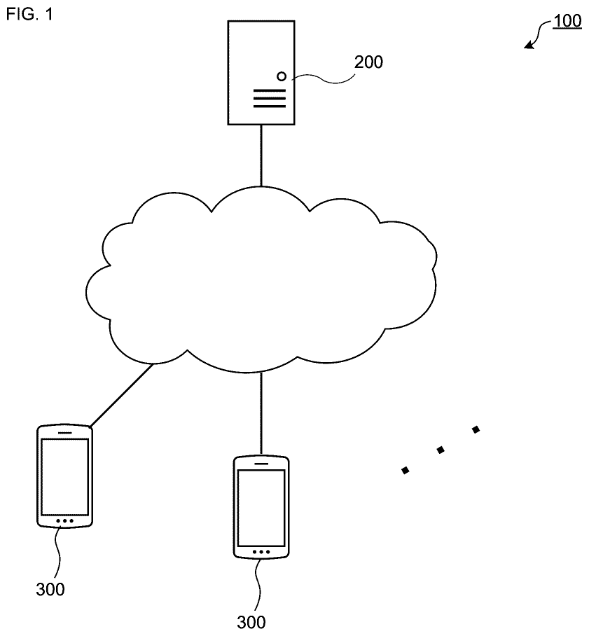

FIG. 1 is a configuration diagram illustrating an information processing system 100. The information processing system 100 includes a server apparatus 200 and an information processing apparatus 300 connected to each other via a network. A detailed description of the components thereof will be given. A system exemplified by the information processing system 100 includes one or more apparatuses or components. Thus, for example, even the information processing apparatus 300 alone is an example of the information processing system 100.

### 1-2. Server Apparatus 200

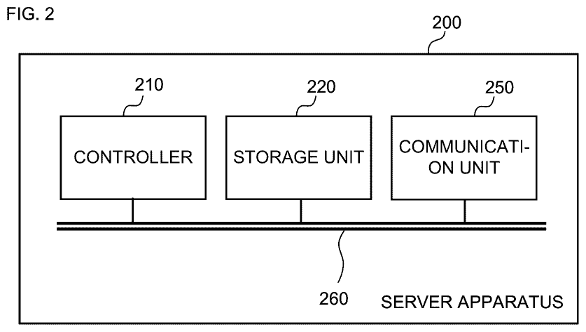

FIG. 2 is a block diagram illustrating a hardware configuration of the server apparatus 200. The server apparatus 200 includes a controller 210, a storage unit 220, and a communication unit 250, and these components are electrically connected inside the server apparatus 200 via a communication bus 260. Each component will be described further.

The controller 210 processes and controls overall operation related to the server apparatus 200. The controller 210 is, for example, a not shown central processing unit (CPU). The controller 210 realizes various functions of the server apparatus 200 by reading a predetermined program stored in the storage unit 220. In other words, by being concretely realized by the controller 210 as an example of hardware, information processing of software stored in the storage unit 220 may be executed as each functional unit included in the controller 210. A description thereof will be given in more detail in the next section. The controller 210 is not limited to being a single controller and may be implemented as two or more controllers 210 for each function or as a combination thereof.

The storage unit 220 stores various information necessary for information processing in the server apparatus 200. The storage unit 220 may be implemented, for example, as a storage device such as a solid state drive (SSD) storing various programs, etc. pertaining to the server apparatus 200 and executed by the controller 210, or as a memory such as a random access memory (RAM) storing temporarily necessary information (arguments, sequences, etc.) pertaining to program operations. The storage unit 220 may also be a combination thereof.

The communication unit 250 may be wired communication means such as USB, IEEE1394, Thunderbolt (registered trademark), wired LAN network communication, and the like, but may include wireless LAN network communication, mobile communication such as 5G/LTE/3G, Bluetooth (registered trademark) communication, and the like as needed. The communication unit 250 may be implemented as a set of two or more of these communication means. In other words, the server apparatus 200 communicates various types of information with the information processing apparatus 300 over a network via the communication unit 250.

### 1-3. Information Processing Apparatus 300

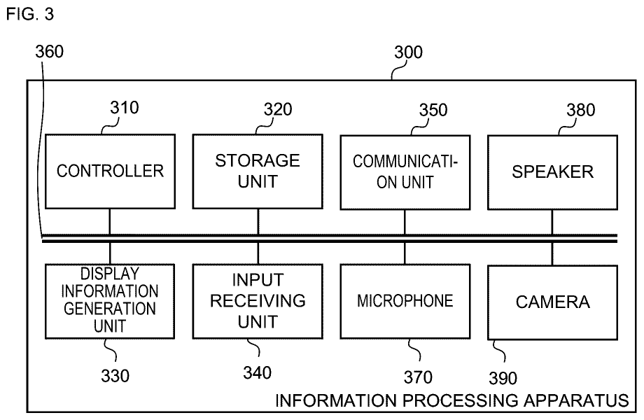

FIG. 3 is a block diagram illustrating a hardware configuration of the information processing apparatus 300. The information processing apparatus 300 includes a controller 310, a storage unit 320, a display information generation unit 330, an input receiving unit 340, a communication unit 350, a microphone 370, a speaker 380, and a camera 390, and these components are electrically connected via a communication bus 360 inside the information processing apparatus 300. A description of the controller 310, the storage unit 320, and the communication unit 350 is omitted as the description thereof is substantially similar to the description of the controller 210, the storage unit 220, and the communication unit 250 in the server apparatus 200.

The display information generation unit 330 displays text and images (including a still image and a motion image), and generates information to be displayed on a display device such as a CRT display, a liquid crystal display, an organic EL display, a plasma display, or the like.

The input receiving unit 340 is used to input various types of information to the information processing apparatus 300 and receives signals input from a mouse, a keyboard, a pointing device, or the like. Operation input made by a user is transmitted as a command signal to the controller 310 via the communication bus 360. The controller 310 may then execute predetermined control or computation as necessary.

The microphone 370 is used to input sound to the information processing apparatus 300 and is an audio device for converting sound into an electrical signal. The directivity of the microphone 370 is not particularly limited, but may be, for example, omni-directional, bi-directional, uni-directional, or the like.

The speaker 380 is used to output sound from the information processing apparatus 300 and is an audio device for converting an electrical signal into sound. The frequency range of the speaker 380 is not limited, but may be, for example, full range, woofer, mid-pass, squawker, tweeter, or the like.

The camera 390 is a camera for recording a captured image as electrical signals and is capable of capturing a still image and a motion image. The camera 390 may have an autofocus function, an exposure time control function, an image stabilization function, or the like.

### 2. Functional Structure

Section 2 describes a functional configuration according to the present embodiment. As described above, when information processing by software stored in the storage unit 320 is specifically realized by the controller 310 as an example of hardware, the information processing may be executed as each functional unit included in the controller 310.

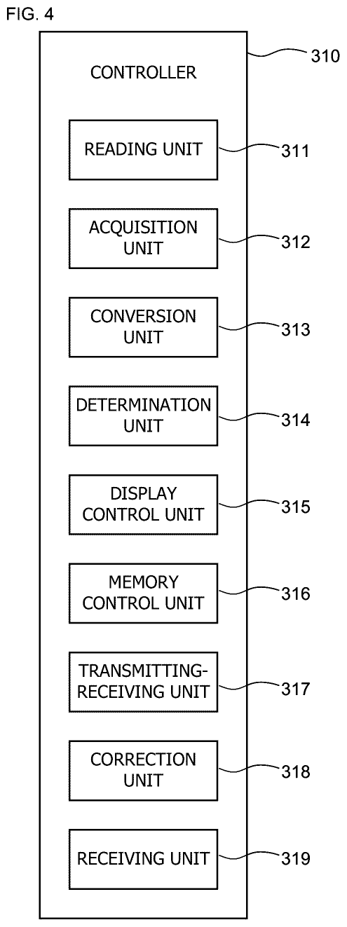

FIG. 4 is a block diagram illustrating functions realized by the information processing apparatus 300 (controller 310). Specifically, the information processing apparatus 300 (controller 310) includes a reading unit 311, an acquisition unit 312, a conversion unit 313, a determination unit 314, a display control unit 315, a memory control unit 316, a transmitting-receiving unit 317, a correction unit 318, and a receiving unit 319.

The reading unit 311 is configured to read various types of information. For example, the reading unit 311 reads, from the storage unit 320, first character information on a character of a teaching material. The reading unit 311 is configured to execute a reading step.

The acquisition unit 312 is configured to acquire various types of information. For example, the acquisition unit 312 acquires, from the microphone 370, a read-aloud sound relating to the first user's voice when the first user reads aloud the first character information. The acquisition unit 312 is configured to execute an acquisition step.

The conversion unit 313 is configured to convert various types of information. For example, the conversion unit 313 converts the acquired read-aloud sound into second character information on a character. The conversion unit 313 is configured to execute a conversion step.

The determination unit 314 is configured to determine various types of information. For example, based on the first character information and the second character information, the determination unit 314 determines a matching point between the first character information and the second character information. The determination unit 314 is configured to execute a determination step.

The display control unit 315 is configured to display various types of information. For example, the display control unit 315 allows the display device of the information processing apparatus 300 to display the matching point in a different display manner from a display manner of the first character information. The display control unit 315 is configured to execute a display control step.

The memory control unit 316 is configured to allow various types of information to be stored. For example, the memory control unit 316 allows the storage unit 320 to store the number of the matching point between the first character information and the second character information. The memory control unit 316 is configured to execute a memory control step.

The transmitting-receiving unit 317 is configured to transmit and receive various types of information. For example, the transmitting-receiving unit 317 allows a message to be transmitted and received between a first user and a second user different from the first user. The transmitting-receiving unit 317 is configured to execute the transmitting-receiving step.

The correction unit 318 is configured to correct various types of information. For example, the correction unit 318 corrects a point of the first character information, the point having been determined to be incorrect by the determination unit 314. The correction unit 318 is configured to execute a correction step.

The receiving unit 319 is configured to receive various types of information. For example, the receiving unit 319 receives a selection operation with respect to an arbitrary character in the first character information. The receiving unit 319 is configured to execute a receiving step.

### 3. Information Processing Method

Section 3 describes an information processing method of the above-described information processing apparatus 300. This information processing method includes a reading step, an acquisition step, a conversion step, a determination step, and a display control step. In the reading step, first character information on a character of a teaching material is read. In the acquisition step, a read-aloud sound relating to a first user's voice when the first user reads aloud the first character information is acquired. In the conversion step, the read-aloud sound is converted into second character information on a character. In the determination step, based on the first character information and the second character information, a matching point between the first character information and the second character information is determined. In the display control step, when there is the matching point, the matching point is displayed in the first character information in a different display manner from a display manner of the first character information.

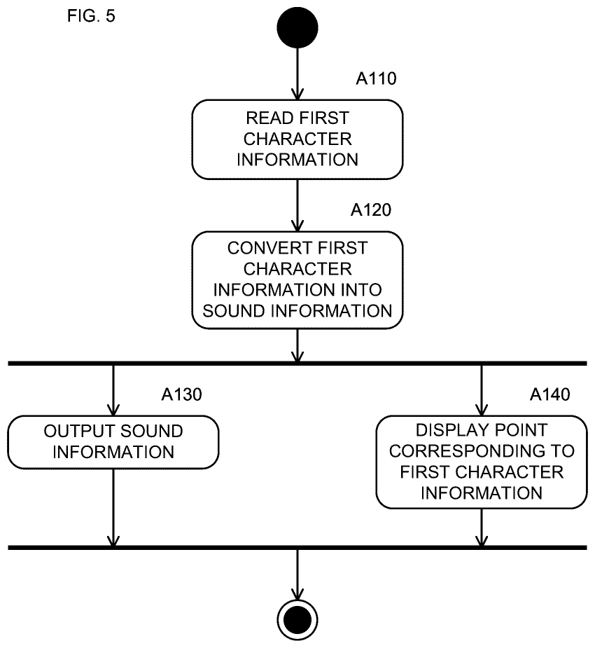

FIG. 5 through FIG. 7 are activity diagrams each illustrating a flow of information processing executed by the information processing apparatus 300. The following description will be given according to each activity in this activity diagram. Here, the “first user” represents a user of the information processing apparatus 300. Hereinafter, “speaking” and “reading aloud” may be described as synonymous.

First, a description is given with reference to each activity in the activity diagram in FIG. FIG. 5 illustrates information processing during execution of listening.

The reading unit 311 reads the first character information on a character of a teaching material (Activity A110). A description is given of a case where the teaching material is a reading material including English text. The first character information may be, for example, a character of font “MS Mincho,” font color “black,” and font size “10.5.”

In Activity A110, for example, the following three steps of information processing are performed. (1) The controller 310 reads the first character information stored in the storage unit 320, the first character information being information on a character of a teaching material. (2) The controller 310 allows the display information generation unit 330 to generate display information for the first character information. (3) The display information generation unit 330 allows the display device of the information processing apparatus 300 to display the first character information.

Thereafter, the conversion unit 313 converts the first character information on the character of the teaching material into sound information (Activity A120). For example, a known conversion program may be used to convert the first character information into the sound information. The sound information includes information as synthesized sound acquired by the conversion program executing a text-to-sound synthesis process.

In Activity A120, for example, the following three steps of information processing are executed. (1) The controller 310 reads the first character information stored in the storage unit 320. (2) The controller 310 executes a conversion process to convert the first character information into sound information. (3) The controller 310 allows the storage unit 320 to store the sound information.

The controller 310 then allows the speaker 380 to output the sound information corresponding to the first character information on the character of the teaching material (Activity A130). In other words, the speaker 380 outputs the sound information (synthesized sound) on sound of reading aloud the character of the teaching material.

In Activity A130, for example, the following two steps of information processing are executed. (1) The controller 310 reads the sound information corresponding to the first character information stored in the storage unit 320. (2) The controller 310 executes an output process to allow the speaker 380 to output the sound information.

Thereafter, the display control unit 315 allows a corresponding point corresponding to the output sound information to be displayed in a display manner different from the display manner of the first character information (activity A140). That is, for example, when the sound information of a word “listening” is output, the display control unit 315 emphasizes display of the part “listening” in the teaching material. As in a display of lyrics in karaoke, after emphasizing a display of a relevant part, the emphasized display may be restored to a normal display after a predetermined time period (e.g., 10 seconds) has elapsed. In this way, the display control unit 315 may allow the corresponding point to be displayed in at least one display manners of a highlighted display, an emphasized-character display, and a display using a font different from the font of the first character information.

Here, a description will be given of each display manner. A highlighted display includes a display manner in which a character string such as a sentence is emphasized by, for example, replacing the background color and the character string with each other. An emphasized-character display includes a display manner in which a character string such as a sentence is displayed in bold, italicized, or underlined manner. A font includes a font, a font color, and a font size, which are assigned to a character string. For example, in a case where the first character information includes a character of a font “MS Mincho,” a font color “black,” and a font size “10.5,” a different font may be a font of at least one of a font “Mayrio,” a font color “red,” and a font size “12.”

In Activity A140, for example, the following four steps of information processing are executed. (1) The controller 310 reads the first character information stored in the storage unit 320. (2) The controller 310 executes a determination process to determine a corresponding point between the output sound information and the first character information. (3) The controller 310 allows the display information generation unit 330 to generate display information for the corresponding point. (4) The controller 310 allows the display device of the information processing apparatus 300 to display the corresponding point.

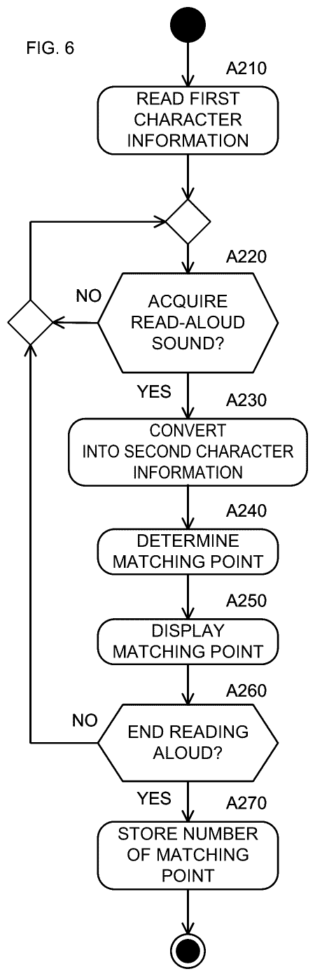

Next, a description is given according to each activity in the activity diagram in FIG. 6. FIG. 6 illustrates information processing during execution of speaking.

The reading unit 311 reads first character information on a character of a teaching material (Activity A210). A description is given of a case where the teaching material is a reading material including English text. The first character information may be, for example, a character of font “MS Mincho,” font color “black,” and font size “10.5.”

In Activity A210, for example, for example, the following three steps of information processing are executed. (1) The controller 310 reads the first character information stored in the storage unit 320, the first character information being information on a character of a teaching material. (2) The controller 310 allows the display information generation unit 330 to generate display information for the first character information. (3) The display information generation unit 330 allows the display device of the information processing apparatus 300 to display the first character information.

Subsequently, the acquisition unit 312 acquires, from the microphone 370, read-aloud sound relating to the first user's voice when the first user reads aloud the first character information (Activity A220).

In Activity A220, for example, the following two steps of information processing are executed. (1) The microphone 370 acquires first user's read-aloud sound. (2) The controller 310 allows the storage unit 320 to store information on the read-aloud sound.

Subsequently, the conversion unit 313 converts the first user's read-aloud sound into second character information on a character (Activity A230). The first user's read-aloud sound may be converted into the second character information by using, for example, a known conversion program.

In Activity A230, for example, the following three steps of information processing are executed. (1) The controller 310 reads information on the read-aloud sound stored in the storage unit 320. (2) The controller 310 executes a conversion process to convert the read-aloud sound into second character information on a character. (3) The controller 310 stores the second character information in the storage unit 320.

Subsequently, based on the first character information on the character of the teaching material and the second character information into which the first user's read-aloud sound has been converted, the determination unit 314 determines a matching point between the first character information and the second character information (Activity A240). That is, for example, in a case where the teaching material includes a word “light” and the first user pronounces “light,” the first character information and the second character information are determined to match. On the other hand, in a case where the first user cannot pronounce “I” and “r” well and pronounces “right” when “light” is written in the teaching material, it is determined that there is no matching point between the first character information and the second character information.

Here, the matching point between the first character information and the second character information may be determined word-by-word (by a word unit) or character-by-character. It may be preferable that the matching point is determined word-by-word. In the above example, it may be determined that there is no matching point for all of the word “light,” or it may be determined that there is no matching point for the character “I” and there is a matching point for the remaining characters “fight.”

In Activity A240, for example, the following three steps of information processing are performed. (1) The controller 310 reads the first character information and the second character information stored in the storage unit 320. (2) The controller 310 executes a determination process to compare the first character information and the second character information and determine a matching point between the first character information and the second character information. (3) The controller 310 allows the storage unit 320 to store information on the matching point.

Next, the display control unit 315 displays the matching point between the first character information and the second character information in a display manner different from the display manner of the first character information (Activity A250). For example, in a case where the word “speaking” is determined to be a matching point, the display control unit 315 allows the part “speaking” in the teaching material to be displayed in emphasized characters. In this way, the display control unit 315 may display the matching point in at least one display manners of a highlighted display, an emphasized-character display, and a display using a font different from the font of the first character information. Here, each display manner is similar to each of those described above.

In Activity A250, for example, the following three steps of information processing are performed. (1) The controller 310 reads information on the matching point stored in the storage unit 320. (2) The controller 310 allows the display information generation unit 330 to generate display information for the matching point. (3) The display information generation unit 330 allows the display device of the information processing apparatus 300 to display the matching point.

Subsequently, the controller 310 determines whether or not the first user has ended reading aloud (Activity A260).

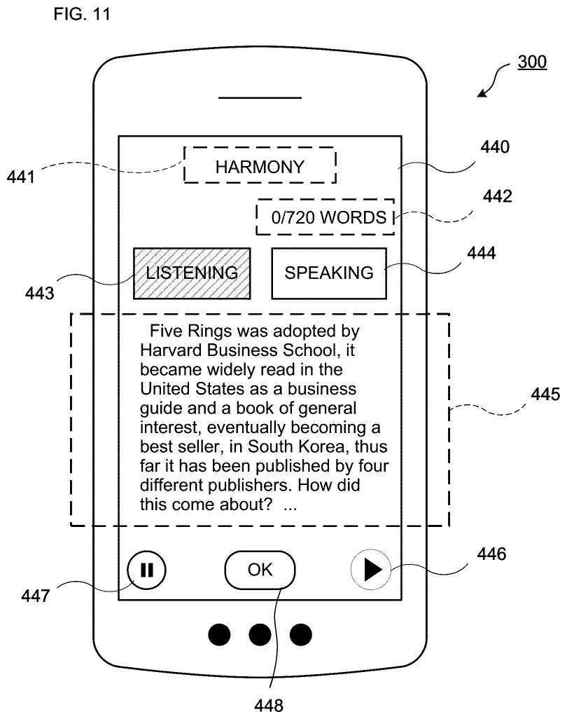

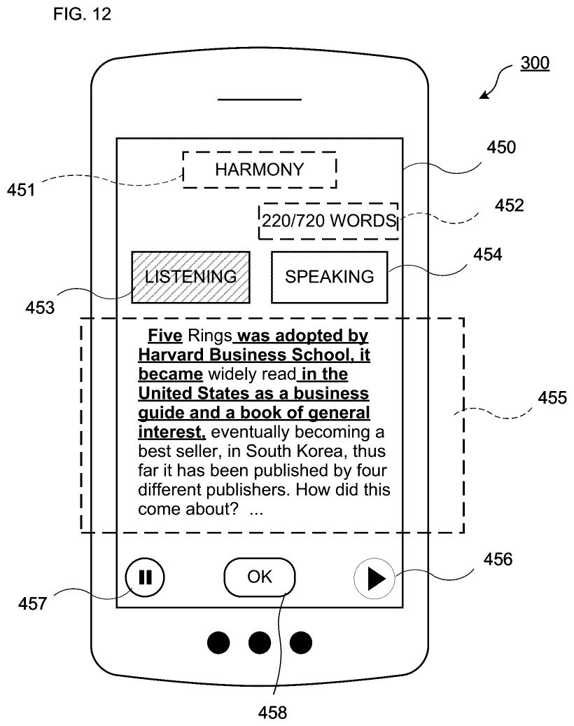

In Activity A260, for example, the following two steps of information processing are performed. (1) The input receiving unit 340 receives an input operation on an OK button 448 on a screen 440 illustrated in FIG. 11 or an OK button 458 on a screen 450 illustrated in FIG. 12. (2) When the controller 310 determines that the input operation has been made to the input receiving unit 340, the controller 310 determines that the first user has ended reading aloud.

Subsequently, the memory control unit 316 stores the number of matching point between the first character information and the second character information (Activity A270). That is, for example, in a case where it is determined that the first user has read aloud each of the words “listening,” “speaking,” and “light” in the teaching material, the number of matching points (number of words) becomes “3.”

In Activity A270, for example, the following three steps of information processing are performed. (1) The controller 310 reads information on the matching point stored in the storage unit 320. (2) The controller 310 executes a calculation process to calculate the number of words in the matching point. (3) The controller 310 allows the storage unit 320 to store the number of words in the matching point.

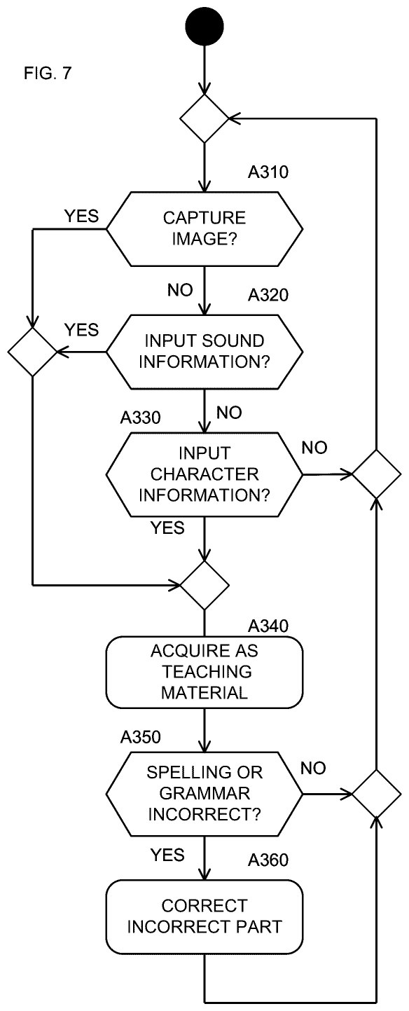

Next, a description is given according to each activity in the activity diagram in FIG. 7. FIG. 7 illustrates information processing during execution of importation of a teaching material.

The controller 310 determines whether or not an image has been captured by the camera 390 (Activity A310). In a case where the controller 310 determines that an image has been captured, the acquisition unit 312 acquires the captured image as a teaching material (Activity A340).

From Activity A310 through Activity A340, for example, the following three steps of information processing are performed. (1) The controller 310 monitors an image capturing process performed by the camera 390. (2) When the controller 310 determines that the camera 390 has performed the image capturing process, the controller 310 determines that an image has been captured by the camera 390. (3) The controller 310 executes an acquisition process and allows the storage unit 320 to store the captured image as a teaching material.

The controller 310 then determines whether or not sound information has been input to the microphone 370 (Activity A320). If it is determined that sound information has been input, the acquisition unit 312 acquires the input sound information as a teaching material (Activity A320).

From Activity A320 through Activity A340, for example, the following three steps of information processing are performed. (1) The controller 310 monitors a sound input process performed by the microphone 370. (2) When the controller 310 determines that the microphone 370 has performed the sound input process, the controller 310 determines that sound information has been input to the microphone 370. (3) The controller 310 executes an acquisition process and allows the storage unit 320 to store the input sound information as a teaching material.

Subsequently, the controller 310 determines whether or not character information has been input to the input receiving unit 340 (Activity A330). In a case where it is determined that character information has been input, the acquisition unit 312 acquires the input character information as a teaching material (Activity A340).

From Activity A330 through Activity A340, for example, the following three steps of information processing are performed. (1) The controller 310 monitors a character input process performed by the input receiving unit 340. (2) When the controller 310 determines that the input receiving unit 340 has performed the character input process, the controller 310 determines that character information has been input to the input receiving unit 340. (3) The controller 310 executes an acquisition process and allows the storage unit 320 to store the input character information as a teaching material.

Subsequently, the determination unit 314 determines whether the spelling and grammar of the character (first character information) in the acquired teaching material is correct or incorrect (Activity A350). For example, in a case where an object of image capturing in Activity A310 includes “Heaven help those who help themselves.,” the determination unit 314 determines that the suffix “s” is missing.

In Activity A350, for example, the following four steps of information processing are performed. (1) The controller 310 reads the first character information on the teaching material stored in the storage unit 320. (2) The controller 310 reads a predetermined program stored in the storage unit 320. (3) The controller 310 executes a determination process to determine whether or not the spelling and the grammar of the first character information on the teaching material is correct. (4) The controller 310 allows the storage unit 320 to store the determination result. Here, the predetermined program may be a known spelling check program or a known grammar check program.

Subsequently, the correction unit 318 corrects part determined to be incorrect in the first character information (Activity A360). For example, in a case where the determination unit 314 makes a determination on a description “Heaven helps those who help themselves.” and determines that the description includes an error, the correction unit 318 corrects the description by replacing it with a correct sentence, such as “Heaven helps those who help themselves.”

In Activity A360, for example, the following three steps of information processing are performed. (1) The controller 310 reads the determination result of the first character information stored in the storage unit 320. (2) The controller 310 reads a predetermined program stored in the storage unit 320. (3) The controller 310 executes a correction process to correct the point determined to be incorrect in the first character information. (4) The controller 310 allows the storage unit 320 to store the corrected first character information. Here, the predetermined program may be a known spelling check program or a known grammar check program.

### 4. Screen Example

Section 4 describes screen examples according to the present embodiment. A “tap operation” in the present embodiment includes a tap operation and a click operation. Here, a second user is a user of the information processing apparatus 300 and is different from the first user.

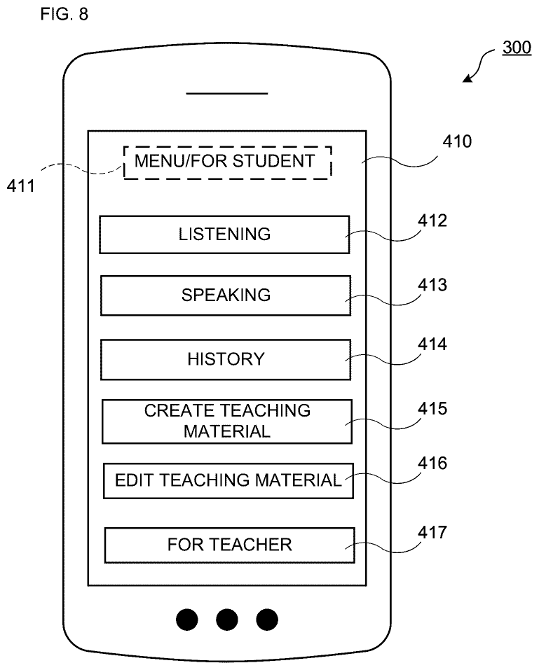

FIG. 8 illustrates an example of a menu screen. A screen 410 as an example of the menu screen displays an area 411, a listening button 412, a speaking button 413, a history button 414, a teaching material creation button 415, a teaching material edit button 416, and a teacher button 417.

The area 411 is an area of displaying a title of a display content on the screen 410. The area 411 displays “MENU/FOR STUDENT.” Thus, it can be seen that the screen 410 is displaying the student menu screen.

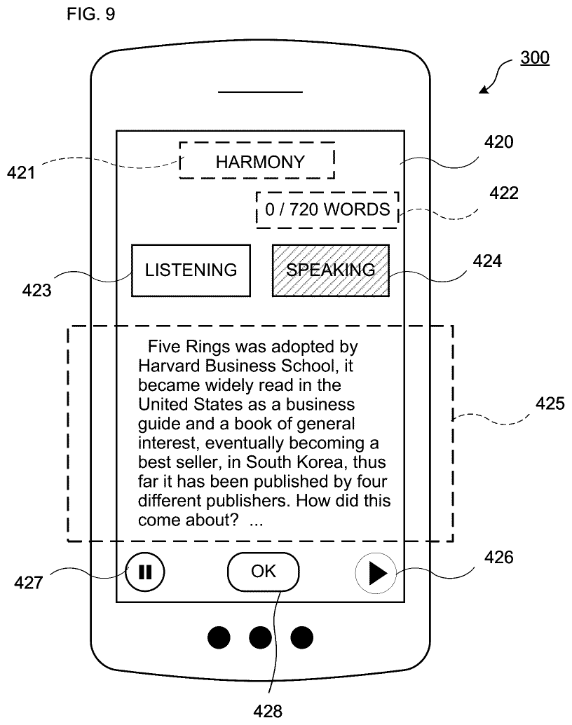

The listening button 412 is a button for starting listening, which is one of the functions of the information processing apparatus 300. A tap operation on the listening button 412 allows a transition to a screen 420 illustrated in FIG. 9.

The speaking button 413 is a button for starting speaking, which is one of the functions of the information processing apparatus 300. A tap operation on the speaking button 413 allows a transition to a screen 440 illustrated in FIG. 11.

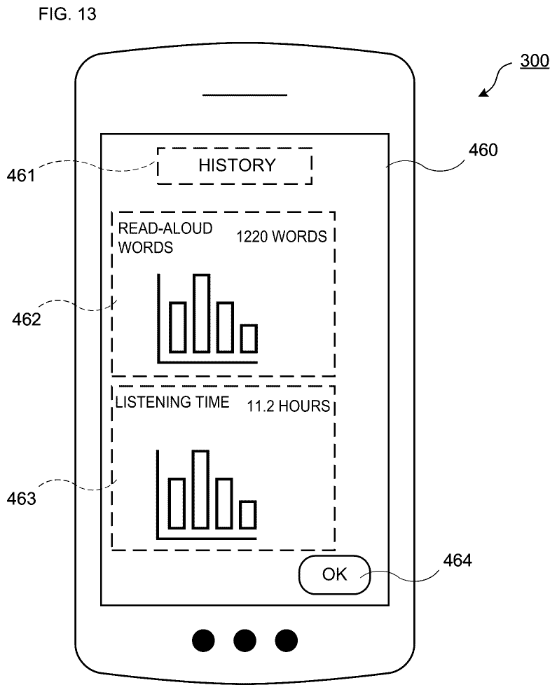

The history button 414 is a button for displaying a history, which is one of the functions of the information processing apparatus 300. A tap operation on the history button 414 allows a transition to a screen 460 illustrated in FIG. 13.

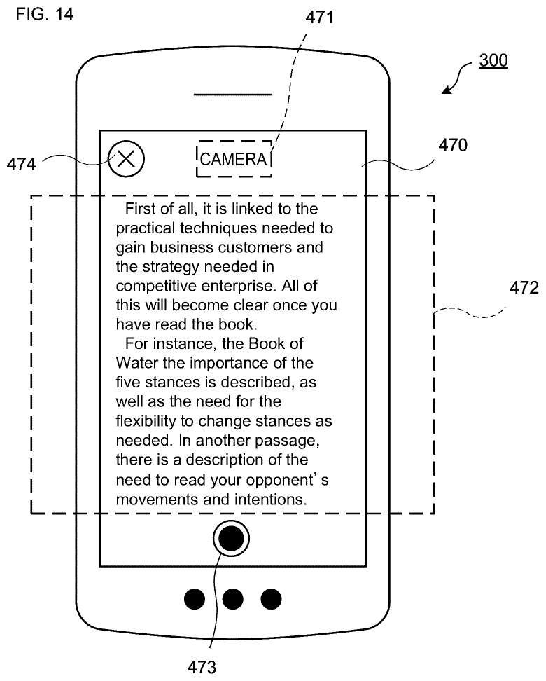

The teaching material creation button 415 is a button for creating a teaching material, which is one of the functions of the information processing apparatus 300. A tap operation on the teaching material creation button 415 allows a transition to a screen 470 illustrated in FIG. 14 as an example of the teaching material creation screen.

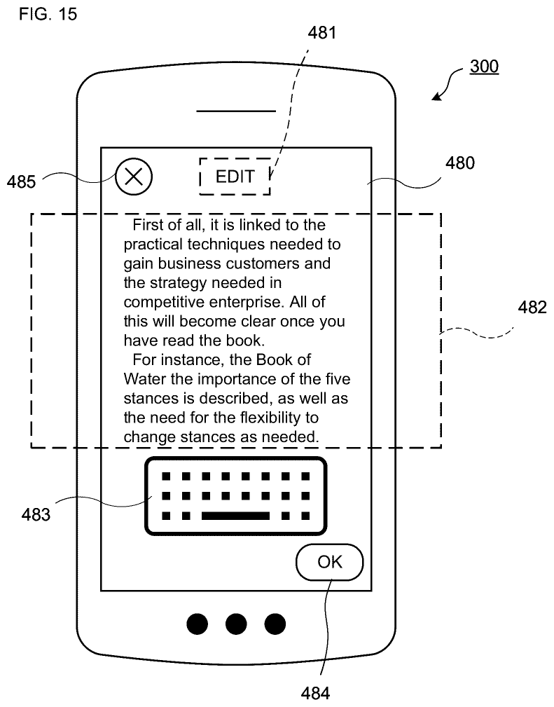

The teaching material edit button 416 is a button for editing a teaching material, which is one of the functions of the information processing apparatus 300. A tap operation on the teaching material edit button 416 allows a transition to a screen 480 illustrated in FIG. 15.

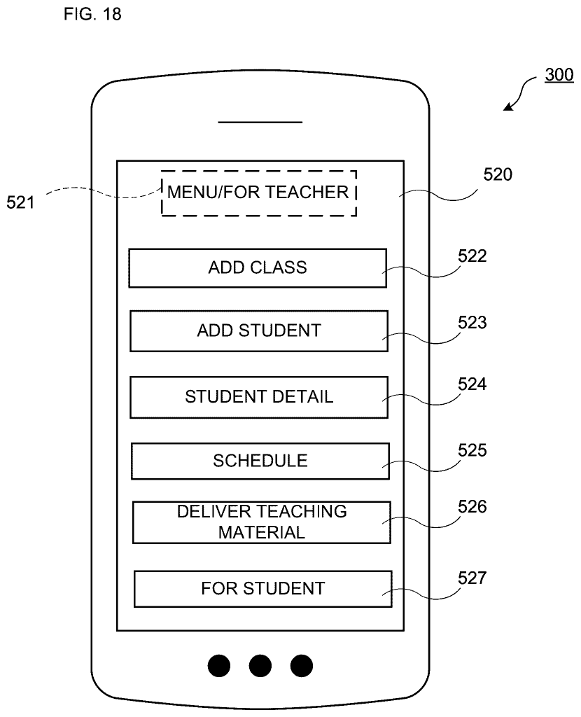

The teacher button 417 is a button for transitioning from the student menu screen to a teacher menu screen. A tap operation on the teacher button 417 allows a transition to a screen 520 illustrated in FIG. 18.

FIG. 9 illustrates an example of a listening start screen. The screen 420 as an example of the listening start screen displays an area 421, an area 422, a listening display 423, a speaking display 424, an area 425, a play button 426, a stop button 427, and an OK button 428.

The area 421 displays a title of the teaching material selected on a teaching material selection screen (not shown). “HARMONY” is displayed in the area 421, and thus it can be seen that listening to the teaching material “HARMONY” will be started.

The area 422 displays the number of words played in listening. The area 422 displays “0/720 WORDS,” and thus it can be seen that the number of words in the teaching material “HARMONY” is 720 and that the listening has not been progressed by this time point.

The listening display 423 is an area displayed as being active when listening is selected. Here, since listening has been selected, the listening display 423 is displayed as being active.

The speaking display 424 is an area displayed as being active when speaking is selected. Here, since listening has been selected, the speaking display 424 is displayed as being inactive.

The area 425 displays a content of a selected teaching material. The area 425 displays the contents of the teaching material “HARMONY” The play button 426 is a button for causing sound of the teaching material to be played. A tap operation on the play button 426 allows the sound corresponding to the teaching material to be played and listening to be started.

The stop button 427 is a button for pausing the listening. A tap operation on the stop button 427 allows the sound corresponding to the teaching material to be stopped and the listening to be paused.

The OK button 428 is a button for ending the listening. A tap operation on the OK button 428 ends listening and allows a transition from the screen 420 to the screen 410.

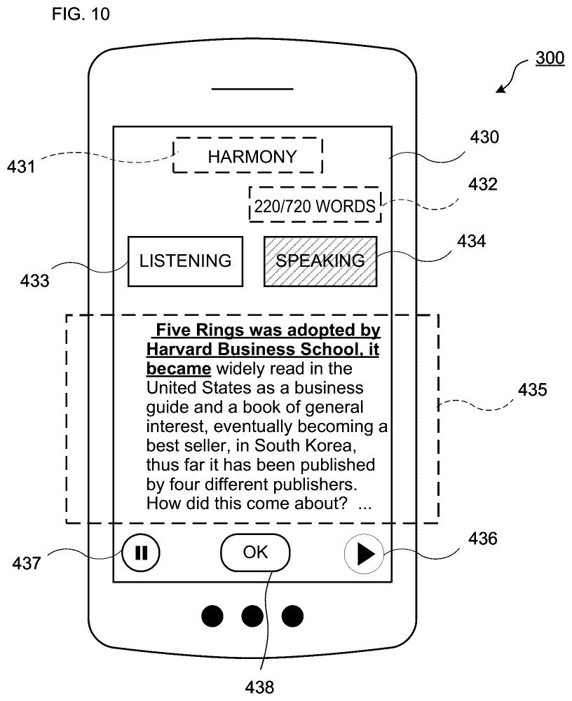

FIG. 10 illustrates an example of a screen during listening. A screen 430 as an example of the screen during listening displays an area 431, an area 432, a listening display 433, a speaking display 434, an area 435, a play button 436, a stop button 437, and an OK button 438. A description is omitted of the area 431, the listening display 433, the speaking display 434, the play button 436, the stop button 437, and the OK button 438 because the description thereof is substantially similar to the description of the area 421, the listening display 423, the speaking display 424, the play button 426, the stop button 427, and the OK button 428.

The area 432 displays the number of words listened to in listening. The area 432 displays “220/720 WORDS,” and therefore it can be seen that the number of words in the teaching material “HARMONY” is 720 words and that 220 words have been played by this time point.

The area 435 displays a content of a selected teaching material. The area 435 displays the contents of the teaching material “HARMONY” The area 435 displays, in highlighted characters, part corresponding to sound played in listening. The display control unit 315 may display a corresponding point corresponding to sound played in listening in at least one display manner of a highlighted display, an emphasized-character display, and a display using a font different from the font of the first character information.

FIG. 11 illustrates an example of a speaking start screen. The screen 440 as an example of the speaking start screen displays an area 441, an area 442, a listening display 443, a speaking display 444, an area 445, a start button 446, a stop button 447, and an OK button 448.

The area 441 displays a title of a teaching material selected on the teaching material selection screen (not shown). The area 441 displays “HARMONY” and thus it can be seen that speaking of the teaching material “HARMONY” will be started.

The area 442 displays the number of words read aloud in speaking. The area 442 displays “0/720 WORDS,” and thus it can be seen that the number of the teaching material “HARMONY” is 720 words and that speaking has not yet been progressed by this time point.

The listening display 443 is an area displayed as being active when listening is selected. Here, since speaking has been selected, the listening display 443 is displayed as being inactive.

The speaking display 444 is an area displayed as being active when speaking is selected. Here, since speaking has been selected, the speaking display 444 is displayed as being active.

The area 445 displays a content of a selected teaching material. The area 445 displays the contents of the teaching material “HARMONY.”

The start button 446 is a button for starting speaking. A tap operation on the start button 446 causes control for allowing the first user's read-aloud sound to be input.

The stop button 447 is a button for pausing the speaking. A tap operation on the stop button 447 allows control to stop the input of the first user's read-aloud sound.

The OK button 448 is a button selected when the speaking ends. A tap operation on the OK button 448 ends speaking and allows a transition from the screen 440 to the screen 410.

FIG. 12 illustrates an example of a screen during speaking. The screen 450 as an example of the screen during speaking displays an area 451, an area 452, a listening display 453, a speaking display 454, an area 455, a start button 456, a stop button 457, and an OK button 458. A description is omitted of the area 451, the listening display 453, the speaking display 454, the start button 456, the stop button 457, and the OK button 458 because the description thereof is substantially similar to the description of the area 441, the listening display 443, the speaking display 444, the start button 446, the stop button 447, and the OK button 448.

The area 452 displays the number of words read aloud in speaking. The area 452 displays “220/720 WORDS,” and it can be seen that the number of words in the teaching material “HARMONY” is 720 words and that 220 words have been read aloud by this time point.

The area 455 displays a content of a selected teaching material. The area 435 displays the contents of the teaching material “HARMONY” The area 455 displays a part corresponding to the first user's read-aloud sound in emphasized characters. The display control unit 315 may display a matching point corresponding to the first user's read-aloud sound in at least one display manner of a highlighted display, an emphasized-character display, and a display using a font different from the font of the first character information.

FIG. 13 illustrates an example of a screen displaying history. The screen 460 as an example of the screen displaying history displays an area 461, an area 462, an area 463, and an OK button 464.

The area 461 is an area of displaying a title of display contents on the screen 460. The area 461 displays a word “HISTORY” Thus, it can be seen that the screen 460 displays a history screen for listening practice and speaking practice.

The area 462 displays the number of words read aloud in speaking. The area 462 displays “1220 WORDS” as the number of words having been read aloud (the number of words read aloud by the first user) and also displays a graph visualizing progress in speaking.

The area 463 displays a playback time in listening. The area 463 displays “11.2 HOURS” as the playback time in listening (time during which the first user has performed listening) and also displays a graph visualizing progress in listening.

The OK button 464 is a button for ending the display of the history. A tap operation on the OK button 464 allows a transition from the screen 460 to the screen 410.

FIG. 14 illustrates an example of a teaching material creation screen. The screen 470 as an example of the teaching material creation screen displays an area 471, an area 472, an image-capturing button 473, and a back button 474. The screen 470 illustrates an example of a case where a teaching material is created from an image captured by the camera 390.

The area 471 is an area of displaying a title of a display content on the screen 470. The area 471 displays a word “CAMERA.” Thus, it can be seen that on the screen 470, a teaching material can be created using the camera 390.

The area 472 displays an object of image capturing by the camera 390. The area 472 displays an English text, indicating that the English text can be imported to create a teaching material.

The image-capturing button 473 is a button for capturing an image of an object to be captured by the camera 390. A tap operation on the image-capturing button 473 allows image capturing of the object to be captured displayed in the area 472. At this time, the controller 310 may perform OCR processing on the captured image of the object and may allow the storage unit 320 to store the processed image as text information.

The back button 474 is a button for ending the image capturing by the camera 390. A tap operation on the back button 474 allows a transition from the screen 470 to the screen 410.

FIG. 15 illustrates an example of a teaching material edit screen. The screen 480 as an example of the teaching material edit screen displays an area 481, an area 482, a keyboard 483, an OK button 484, and a back button 485.

The area 481 is an area of displaying a title of a display content on the screen 480. The area 481 displays “EDIT.” Thus, it can be seen that the screen 480 is a screen for editing teaching materials.

The area 482 displays a teaching material as an object to be edited. The area 482 displays a content of a teaching material, and a tap operation on any point of the area 482 makes the corresponding part editable.

The keyboard 483 is used to edit the teaching material displayed in the area 482. A tap operation on the keyboard 483 allows execution of character input or a deletion process in the corresponding part.

The OK button 484 is a button for ending the editing of the teaching material. A tap operation on the OK button 484 allows the currently edited content to be stored and then allows a transition from the screen 480 to the screen 410.

The back button 485 is a button for ending the editing of the teaching material. A tap operation on the back button 485 allows the currently edited content to be discarded and then allows a transition from the screen 480 to the screen 410.

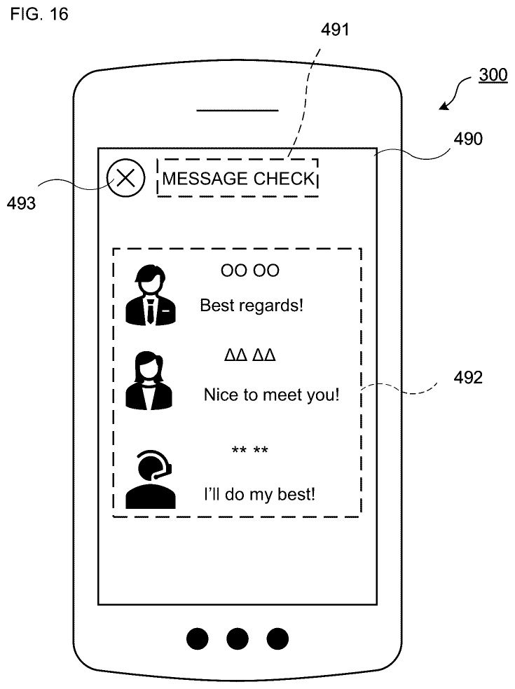

FIG. 16 illustrates an example of a message check screen. A screen 490 as an example of the message check screen displays an area 491, an area 492, and a back button 493.

The area 491 is an area of displaying a title of a display content on the screen 490. The area 491 displays “MESSAGE CHECK.” Thus, it can be seen that the screen 490 is a screen for checking a message communicated with the second user.

The area 492 is an area for displaying a message between the first user and the second user. An arbitrary second user can be selected in the area 492, and when the second user is selected, the screen is transitioned from the screen 490 to screen 510. The area 492 displays a message “Best regards!” from a second user “OO OO,” a message “Nice to meet you!” from a second user “ΔΔ ΔΔ,” and a message “I'll do my best!” from a second user “** **.”

The back button 493 is a button for ending the message check. A tap operation on the back button 493 allows a transition from the screen 490 to the screen 410.

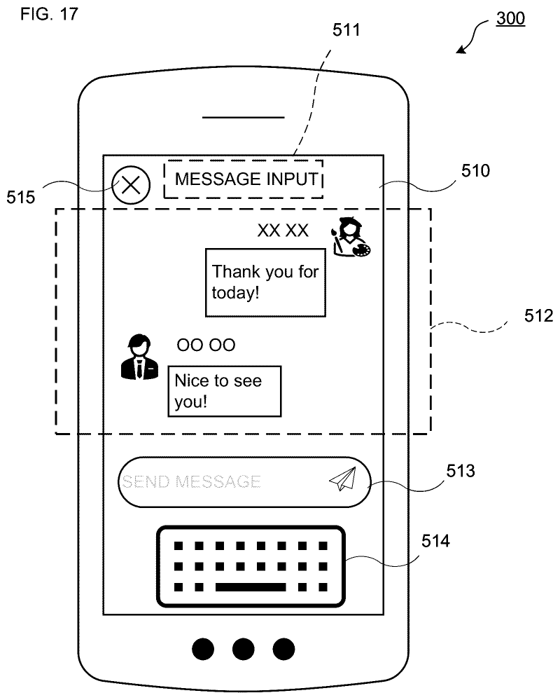

FIG. 17 illustrates an example of a message input screen. A screen 510 as an example of the message input screen displays an area 511, an area 512, an input box 513, a keyboard 514, and a back button 515.

The area 511 is an area of displaying a title of a display content on the screen 510. The area 511 displays “MESSAGE INPUT.” Thus, it can be seen that the screen that the screen 510 is a screen for inputting a message to the second user.

The area 512 is an area for displaying a message between the first user and the second user. The area 512 displays a message “Thank you for today!” from the first user “XX XX,” and a message “Nice to see you!” from the second user “OO OO.”

The input box 513 is a box from which a message to the second user “OO OO” can be input. A tap operation on the input box 513 allows reception of character input from the keyboard 514.

The keyboard 514 is for allowing a message to be input to the input box 513. A tap operation on the keyboard 514 allows input of a character to the input box 513. When a tap operation on a transmission icon on the input box 513 is performed after the character input from the keyboard 514 is ended, the input message is allowed to be transmitted to the second user “OO OO.”

The back button 515 is a button for ending the message input. A tap operation on the back button 515 allows a transition from the screen 510 to the screen 410.

As illustrated in FIG. 17, the transmitting-receiving unit 317 may be configured to transmit and receive a message between the first user and a second user different from the first user.

FIG. 18 illustrates an example of a menu screen. A screen 520 as an example of the menu screen displays an area 521, a class addition button 522, a student addition button 523, a student detail button 524, a schedule button 525, a teaching material delivery button 526, and a student button 527. In the following description, a first user is assumed to be a teacher and a second user is assumed to be a student.

The area 521 is an area of displaying a title of a display content on the screen 520. The area 521 displays “MENU/FOR TEACHER.” Thus, it can be seen that the screen 520 displays a menu screen for teacher.

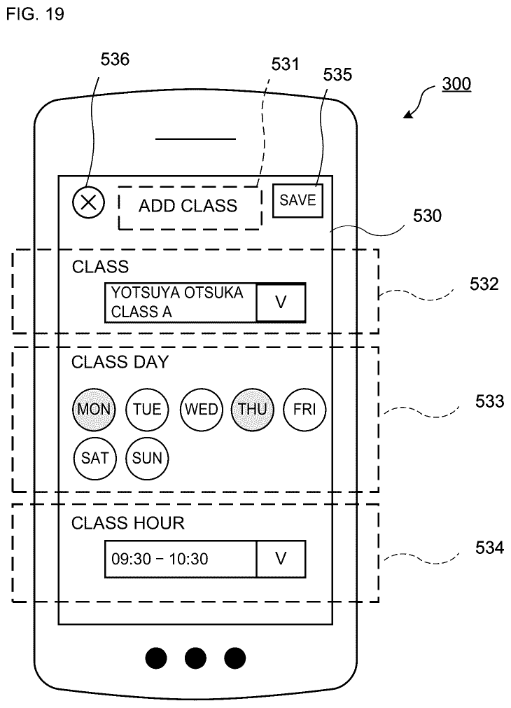

The class addition button 522 is a button for adding a class. A tap operation on the class addition button 522 allows a transition to a screen 530 illustrated in FIG. 19.

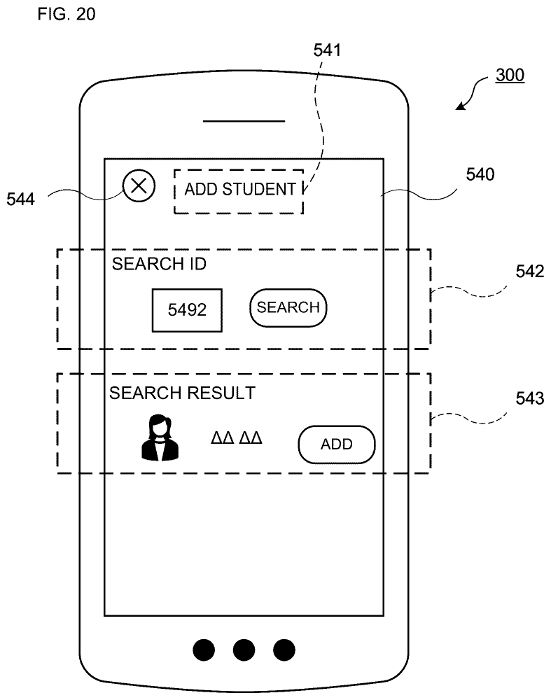

The student addition button 523 is a button for adding a student. A tap operation on the student addition button 523 allows a transition to a screen 540 illustrated in FIG. 20.

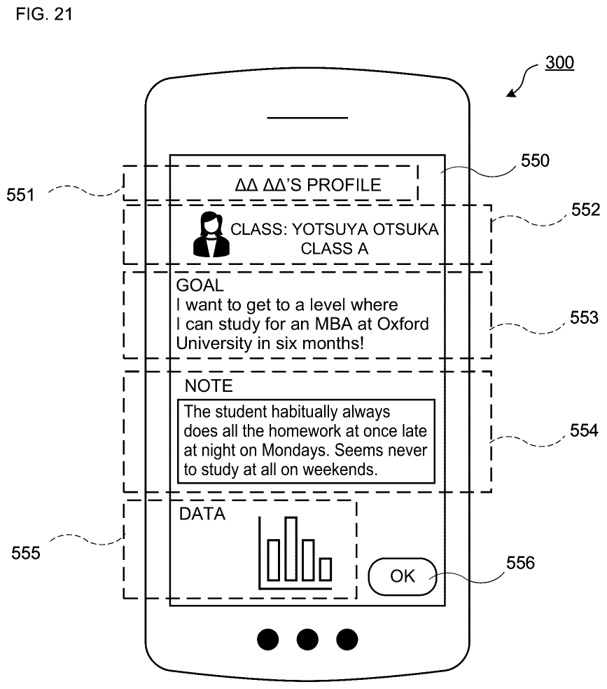

The student detail button 524 is a button for viewing details about a student. A tap operation on the student detail button 524 allows a transition to a screen 550 illustrated in FIG. 21.

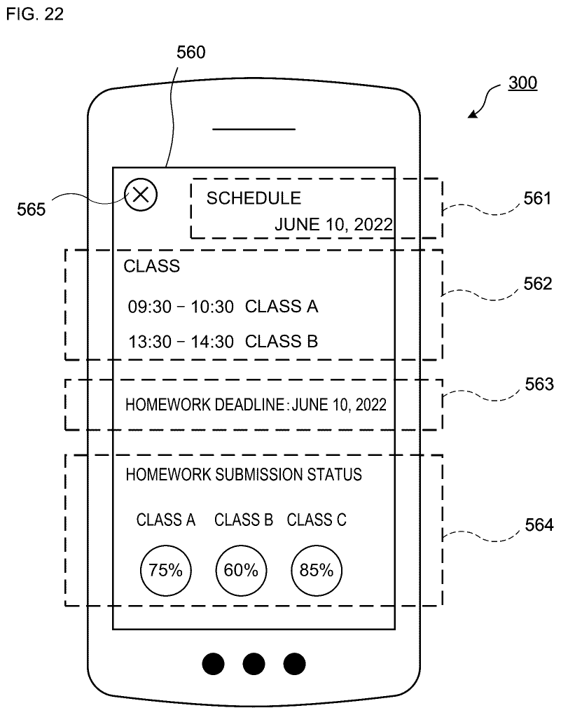

The schedule button 525 is a button for setting a schedule. A tap operation on the schedule button 525 allows a transition to a screen 560 illustrated in FIG. 22.

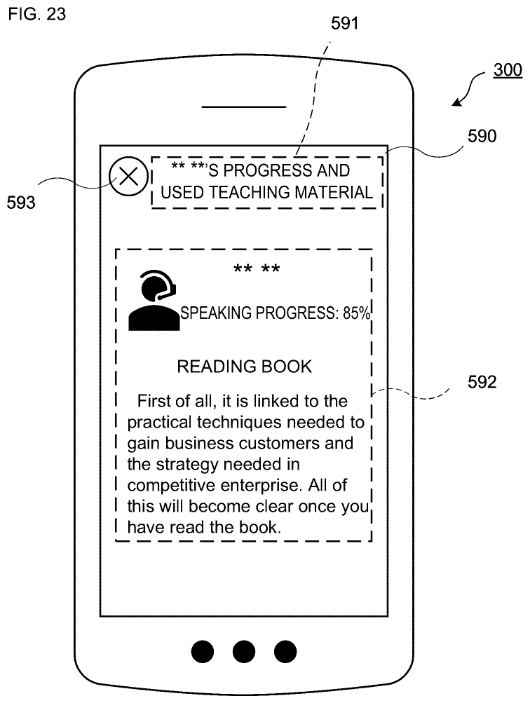

The teaching material delivery button 526 is a button for delivering a teaching material. A tap operation on the teaching material delivery button 526 allows a transition to a screen 570 illustrated in FIG. 23.

The student button 527 is a button for transitioning from the menu screen for teacher to the menu screen for student. A tap operation on the student button 527 allows a transition to the screen 410 illustrated in FIG. 8.

FIG. 19 illustrates an example of a class addition screen. The screen 530 as an example of the class addition screen displays an area 531, an area 532, an area 533, an area 534, a save button 535, and a back button 536.

The area 531 is an area of displaying a title of a display content on the screen 530. The area 531 displays “ADD CLASS.” Thus, it can be seen that the screen 530 is a screen for adding a class.

The area 532 is an area for selecting a class to be added. The area 532 displays a name of a class to be added and allows selection of the class from a pull-down menu. In the area 532, “YOTSUYA OTSUKA CLASS A” is selected.

The area 533 is an area for setting a class day of the week for the class selected in the area 532. A tap operation on the area 533 allows selection of a corresponding day of the week. In the area 533, Monday and Thursday are selected.

The area 534 is an area for setting a class hour for the class selected in the area 532. The area 534 displays a selectable class hour and allows setting of the class hour from a pull-down menu. In the area 534, the class hour for the Yotsuya Otsuka class A is set to “09:30 to 10:30.”

The save button 535 is a button for saving the contents selected or set in the areas 532, 533, and 534. A tap operation on the save button 535 allows the controller 310 to operate so that the storage unit 320 stores the above-described selections or settings.

The back button 536 is a button for discarding the selections or settings made in the areas 532, 533, and 534. A tap operation on the back button 536 allows the above-described selections or settings to be discarded and thereafter allows a transition to the screen 520.

FIG. 20 illustrates an example of a student addition screen. The screen 540 as an example of the student addition screen displays an area 541, an area 542, an area 543, and a back button 544.

The area 541 is an area of displaying a title of a display content on the screen 540. The area 541 displays “ADD STUDENT.” Thus, it can be seen that the screen 540 is a screen for adding a student.

The area 542 is an area for searching for a student. When, in the area 542, a tap operation is performed on a search button in a state where a student's ID is entered in an ID search box, a search result is reflected in the area 543.

The area 543 is an area of displaying a result of the search in the area 542. The area 543 displays a second user “ΔΔ ΔΔ.” In the area 543, when the searched student (second user “ΔΔ ΔΔ”) is to be added, a tap operation on an add button allows the second user “ΔΔ ΔΔ” to be added and stored in the storage unit 320.

The back button 544 is a button for discarding the result of the search from the area 543. A tap operation on the back button 544 allows the current search result to be discarded and thereafter allows a transition to the screen 520.

FIG. 21 illustrates an example of a student detail display screen. The screen 550 as an example of thy student detail display screen illustrates an area 551, an area 552, an area 553, an area 554, an area 555, and an OK button 556.

The area 551 is an area of displaying a title of a display content on the screen 550. The area 551 displays “ΔΔ ΔΔ'S PROFILE.” Thus, it can be seen that the screen 550 is a screen displaying the profile of the second user “ΔΔ ΔΔ” who is a student.

The area 552 is an area of displaying an icon and class of the student displayed in the area 551. The area 552 displays an icon and a class of the second user “ΔΔ ΔΔ.”

The area 553 is an area of displaying a goal of the student displayed in the area 551. The area 553 displays the goal “I want to get to a level where I can study for an MBA at Oxford University in six months!” of the second user “ΔΔ ΔΔ.” The teacher (first user) can check the goal and make a plan for reading aloud instruction for the student (second user).

The area 554 is an area of displaying a note about the student displayed in the area 551. The area 554 may only be viewable by a person who wrote the note (the first user in the present embodiment). The area 554 allows a note to be input to an input box. The area 554 includes a description “The student habitually always does all the homework at once late at night on Mondays. Seems never to study at all on weekends.” The teacher (first user) can check the note and make a plan for reading aloud instruction for the student (second user).

The area 555 is an area of displaying data of the student displayed in the area 551. The area 555 may display student's progress in reading aloud as an example of the data.

The OK button 556 is a button for ending the display of the student's detail. A tap operation on the OK button 556 allows a transition to the screen 520.

FIG. 22 illustrates an example of a schedule management screen. The screen 560 as an example of the schedule management screen displays an area 561, an area 562, an area 563, an area 564, and a back button 565.

The area 561 is an area of displaying a title of a display content on the screen 560. The area 561 displays “SCHEDULE” and “Jun. 10, 2022.” Thus, it can be seen that the screen 560 is a screen displaying a schedule of reading aloud instruction on Jun. 10, 2022.

The area 562 is an area of displaying a class schedule of each class. The area 562 displays that there are a class for Class A from 09:30 to 10:30 and a class for Class B from 13:30 to 14:30.

The area 563 displays a deadline for submitting set homework. From the area 563, it can be seen that the deadline for submitting the set homework is set to Jun. 10, 2022.

The area 564 displays a homework submission status for each class. The area 564 displays that 75% of students in Class A have submitted their homework, 60% of students in Class B have submitted their homework, and 85% of students in Class C have submitted their homework. Selecting a class in the area 564 may allow a submission status of each student in the selected class to be viewed.

The back button 565 is a button for ending the schedule check. A tap operation on the back button 565 allows a transition to the screen 520.

As illustrated in FIG. 22, the acquisition unit 312 may acquire progress information on progress in reading aloud of a second user different from a first user.

FIG. 23 illustrates an example of a display screen of first teaching material information. A screen 590 as an example of the display screen of the first teaching material information displays an area 591, an area 592, and a back button 593. The screen 590 may be displayed in a case where, for example, an arbitrary class in the area 564 of the screen 560 is selected and an arbitrary student in the class is selected. Here, the first teaching material information may be, for example, a title of a teaching material, information on a source from which the teaching material was acquired, or a part of the teaching material (e.g., lines 1 through 10 of the teaching material).

The area 591 is an area of displaying a title of a display content on the screen 590. The area 591 displays “** **'S PROGRESS AND USED TEACHING MATERIAL.” Thus, it can be seen that the screen 590 is a screen displaying a progress status of a second user “** **” in reading aloud and information on a teaching material used by the second user “** **.”

The area 592 displays a progress status of the second user “** **” in reading aloud and information on the teaching material used by the second user “** **.” Specifically, the area 592 displays the progress status 85% of the second user “** **” in reading aloud, the title “READING BOOK” of the teaching material used by the second user “** **,” and part of the teaching material “READING BOOK.”

The back button 593 is a button for ending the display of the first teaching material information. A tap operation on the back button 575 allows a transition to the screen 520.

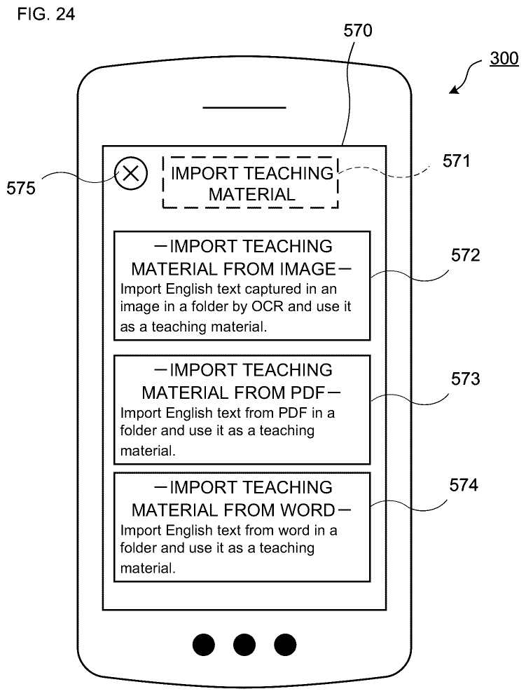

As illustrated in FIG. 23, the display control unit 315 may allow a first user's information processing apparatus 300 to display first teaching material information on a teaching material used by a second user with more than a predetermined level of progress. The more than a predetermined level of progress may be, for example, 80% or more of set progress in reading aloud, or may be 51% or more when first user's progress in reading aloud is 50%. FIG. 24 illustrates an example of a screen for importing a teaching material. The screen 570 as an example of the screen for importing a teaching material displays an area 571, an import button 572, an import button 573, an import button 574, and a back button 575.

The area 571 is an area of displaying a title of a display content on the screen 570. The area 571 displays “IMPORT TEACHING MATERIAL.” Thus, it can be seen that the screen 570 is the screen for importing a teaching material from an image, a PDF file, or a word file and preparing to deliver the teaching material.

The importing button 572 is a button for importing a teaching material from an image. A tap operation on the importing button 572 provides control such that English text captured in an image in a folder is imported by OCR. After this control, the controller 310 allows a transition to a screen 580.

The import button 573 is a button for importing a teaching material from a PDF file. A tap operation on the import button 573 provides control such that English text in a PDF file in a folder is imported. After this control, the controller 310 allows a transition to the screen 580.

The import button 574 is a button for importing a teaching material from a word file. A tap operation on the import button 574 provides control such that English text in a word file in a folder is imported. After this control, the controller 310 allows a transition to the screen 580.

The back button 575 is a button for ending the import of the teaching material. A tap operation on the back button 575 allows a transition to the screen 520.

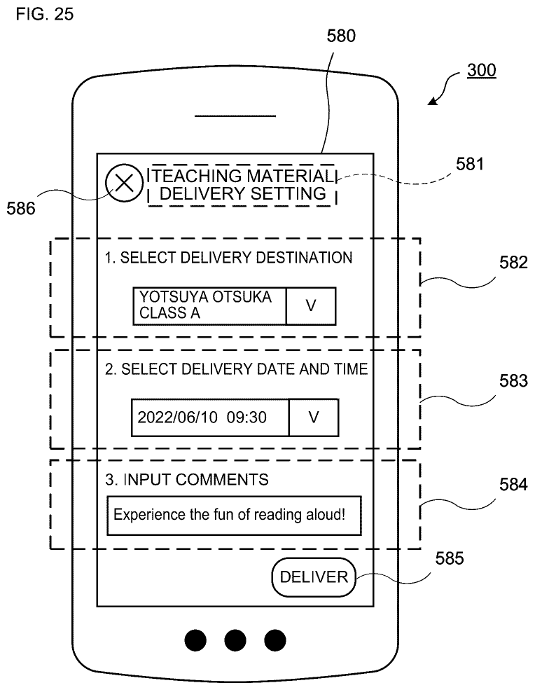

FIG. 25 illustrates an example of a setting screen for delivery of a teaching material. The screen 580 as an example of the setting screen for delivery of a teaching material displays an area 581, an area 582, an area 583, an area 584, a delivery button 585, and a back button 586.

The area 581 is an area of displaying a title of a display content on the screen 580. The area 581 displays “TEACHING MATERIAL DELIVERY SETTING.” Thus, it can be seen that the screen 580 is a setting screen for delivery of a teaching material.

The area 582 is an area for selecting a delivery destination of the teaching material. The area 582 displays a name of a class as a delivery destination and allows a class to be selected from a pull-down menu. In the area 582, “YOTSUYA OTSUKA CLASS A” is selected. In the area 582, two or more classes may be selected.

The area 583 is an area for selecting date and time for delivery to the delivery destination selected in the area 582. The area 583 displays a target delivery date and time and allows the delivery date and time to be selected from a pull-down menu. In the area 583, the delivery is set to be made at 09:30 on Jun. 10, 2022.

The area 584 is an area for entering comments to be added in the delivery of the teaching material. The area 584 may include, for example, a supportive message to a student so that the student experiences the fun of reading aloud. In the area 584, “Experience the fun of reading aloud!” is described.

The delivery button 585 is a button for delivering the imported teaching material in the settings set in the areas 582, 583, and 584. A tap operation on the delivery button 585 allows delivery to the destination of the teaching material imported on the screen 570.

The back button 586 is a button for ending the delivery of the teaching material. A tap operation on the back button 586 allows a transition to the screen 520.

As illustrated in FIG. 25, the transmitting-receiving unit 317 is configured to transmit and receive a teaching material between a first user and a second user different from the first user.

### 5. Aspects of the Present Embodiment

Section 5 describes each aspect of the present embodiment.

In one aspect of the present embodiment, an information processing method includes a reading step, an acquisition step, a conversion step, a determination step, and a display control step. In the reading step, first character information on a character of a teaching material is read. In the acquisition step, a read-aloud sound relating to a first user's voice when the first user reads aloud the first character information is acquired. In the conversion step, the read-aloud sound is converted into second character information on a character. In the determination step, based on the first character information and the second character information, a matching point between the first character information and the second character information is determined. In the display control step, when there is the matching point, the matching point is displayed in the first character information in a different display manner from a display manner of the first character information.

English language instruction in schools is provided in simple phonics instruction at the beginning, followed by a transition to reading aloud of text from a textbook. In many cases, reading aloud instruction is also provided in teaching of a content of a textbook.

However, those who are not good at English tend to become unable to read English sentences because, even when they are provided with reading aloud instruction, they may not keep up with where to read in English text. In addition, since those who are not good at English tend to become unable to read English sentences as described above, they sometimes dislike English.

Therefore, according to an aspect of the present embodiment, by providing an individual independent learning experience, an opportunity to gain awareness about reading aloud can be given, and as a result, the fun of reading aloud can be experienced. Therefore, according to an aspect of the present embodiment, in that it is possible to let a user experience the fun of reading aloud, an improvement can be provided in a control function of a computer in the art relating to reading aloud.

Here, the individual independent learning experience is not for a learning application focusing on increasing English test scores, mastering English, or the like, but rather for promoting individual user spontaneity. Promoting spontaneity of individual users results in improvement in reading aloud (speaking), thus enabling the users to experience the fun of reading aloud.

In one aspect of the present embodiment, in the display control step, the matching point is displayed in at least one display manner of (a) a highlighted display, (b) an emphasized-character display, and (c) a display using a font different from a font of the first character information.

According to such an aspect, when an individual independent learning experience is provided, read aloud part can be easily viewed.

In one aspect of the present embodiment, in the acquisition step, a captured image is acquired as the teaching material.

According to such an aspect, in a case where an individual independent learning experience is provided, when, for example, there is a good sign on a street, an image of the sign can be captured and the image can be acquired as a teaching material, making it possible to make a user enjoy reading aloud.

In one aspect of the present embodiment, in the acquisition step, input sound information is acquired as the teaching material.

According to such an aspect, in a case where an individual independent learning experience is provided, when, for example, there is a favorite foreign music, sound information on this foreign music can be acquired as a teaching material, making it possible to make a user enjoy reading aloud.

In one aspect of the present embodiment, in the acquisition step, input character information is acquired as the teaching material.

According to such an aspect, in a case where an individual independent learning experience is provided, when, for example, there is a favorite fairy tale from overseas, text of this fairy tale can be acquired as a teaching material, making it possible to make a user enjoy reading aloud.

In one aspect of the present embodiment, the information processing method further includes a memory control step. In the memory control step, the number of the matching point is stored.

According to this aspect, when an individual independent learning experience is provided, reading aloud history can be viewed, making it possible to improve user's motivation for reading aloud.

In one aspect of the present embodiment, in the acquisition step, progress information is acquired, the progress information being information on progress in reading aloud of a second user different from the first user.

According to such an aspect, when an individual independent learning experience is provided, since a user can check progress of the other user, the user can encourage the other user, and it is possible to improve motivation for reading aloud of both the user and the other user.

In one aspect of the present embodiment, in the display control step, first teaching material information on a teaching material used by a second user with more than a predetermined level of progress is displayed.

According to this aspect, when an individual independent learning experience is provided, sharing information on a teaching material used by a user with more than a predetermined level of progress can lead to make a user with slower progress than the user with more than the predetermined level of progress become interested in the teaching material and motivated to read the teaching material aloud.

In one aspect of the present embodiment, the information processing method further includes a transmitting-receiving step. In the transmitting-receiving step, message is transmitted and received between the first user and a second user different from the first user.

According to this aspect, when an individual independent learning experience is provided, users can exchange opinions with each other about reading aloud, which can increase their motivation in reading aloud.

In one aspect of the present embodiment, the information processing method further includes a transmitting-receiving step. In the transmitting-receiving step, a teaching material is transmitted and received between the first user and a second user different from the first user.

According to this aspect, when an individual independent learning experience is provided, a user can gain awareness in reading aloud by reading aloud the other user's favorite teaching material.

In one aspect of the present embodiment, in the conversion step, the first character information is converted into sound information. In the display control step, a corresponding point is displayed in a display manner different from the display manner of the first character information, the corresponding point corresponding to the sound information that has been output.

According to such an aspect, when an individual independent learning experience is provided, listening before reading aloud allows a user to easily understand where the user is reading in the teaching material.

In one aspect of the present embodiment, the information processing method further includes a receiving step. In the receiving step, a selection operation with respect to an arbitrary character in the first character information is received. In the conversion step, the selected character is converted into sound information.

According to such an aspect, when an individual independent learning experience is provided, it is possible to check a pronunciation of a word of concern, which leads to acquisition of correct pronunciation and provides an experience of the fun of reading aloud.

In one aspect of the present embodiment, in the display control step, the corresponding point is displayed in at least one display manner of (a) a highlighted display, (b) an emphasized-character display, and (c) a display using a font different from a font of the first character information.

According to such an aspect, when an individual independent learning experience is provided, a listened part can be easily viewed.

In one aspect of the present embodiment, the information processing method further includes a correction step. In the determination step, at least one of spelling and grammar of the first character information is determined to be correct or incorrect. In the correction step, a point determined to be incorrect in the first character information is corrected.

According to such an aspect, when an individual independent learning experience is provided, correct text can be read aloud, improving a user's ability to understand the text.

In one aspect of the present embodiment, in the acquisition step, usage of the teaching material is acquired. In the display control step, second teaching material information is displayed, the second teaching material information being information on a teaching material that has been used more than a predetermined level.

According to this aspect, when an individual independent learning experience is provided, sharing information on a teaching material used by a lot of users can lead to make another user become interested in the teaching material and motivated to read the teaching material aloud.

In one aspect of the present embodiment, a non-transitory computer-readable memory medium storing a program that allows a computer to execute each step of the information processing method.

According to such an aspect, when the memory medium is provided, in a case where an individual independent learning experience is provided, an opportunity to gain awareness about reading aloud can be given, and as a result, the fun of reading aloud can be experienced. Therefore, according to one aspect of the present embodiment, in that it is possible to let a user experience the fun of reading aloud, an improvement can be provided in a control function of a computer in the art relating to reading aloud.

In one aspect of the present embodiment, the information processing apparatus 300 includes a processor configured to execute a program so as to execute each step of the information processing method.

According to such an aspect, when the information processing apparatus is provided, in a case where an individual independent learning experience is provided, an opportunity to gain awareness about reading aloud can be given, and as a result, the fun of reading aloud can be experienced. Therefore, according to one aspect of the present embodiment, in that it is possible to let a user experience the fun of reading aloud, an improvement can be provided in a control function of a computer in the art relating to reading aloud.

### 6. Other Embodiments

A description has been given of the embodiment of the present disclosure, but the present disclosure is not limited thereto, and can be modified as appropriate within a spirit of the disclosure.

An aspect of the present embodiment may be a program. The program allows a computer to execute each step of the information processing method.

An aspect of the present embodiment may be a memory medium. The memory medium is a non-transitory computer-readable memory medium. The memory medium stores a program that allows a computer to execute each step of the information processing method.

As a first modification example, the controller 310 performs a writing process (storing process) to and a reading process from the storage unit 320 for various data and various information, but the controller 310 is not limited thereto and may, for example, use a register, a cache memory, or the like in the controller 310 to perform information processing for each activity.

As a second modification example, a language used in a teaching material is not particularly limited to English, but may be another language, such as Japanese, Chinese, Korean, German, and French.

As a third modification example, in the menu screen for teacher displays the class addition button 522, but may also display a separate class removal button to allow removal of a corresponding class.

As a fourth modification example, the menu screen for teacher displays the student addition button 523, but may also display a separate student removal button to allow removal of a corresponding student.

As a fifth modification example, the information processing apparatus 300 and the server apparatus 200 may be configured to transmit and receive information on a teaching material. For example, the communication unit 350 of the information processing apparatus 300 may transmit character information on the teaching material to the communication unit 250 of the server apparatus 200, the controller 210 of the server apparatus 200 may execute internal processing, and the communication unit 250 of the server apparatus 200 may transmit, to the communication unit 350 of the information processing apparatus 300, sound information corresponding to the character information.

As a sixth modification example, the acquisition unit 312 may acquire a usage of a teaching material, and the display control unit 315 may display second teaching material information on a teaching material having been used more than a predetermined level. Here, the second teaching material information may be, for example, a title of a teaching material, information on a source from which the teaching material was acquired, or part of the teaching material (e.g., lines 1 through 10 of the teaching material).

In the sixth modification example, for example, the following three steps of information processing are performed. (1) From two or more information processing apparatuses 300, the server apparatus 200 acquires usage of teaching materials. (2) The controller 310 acquires the usage of each teaching material stored in the storage unit 220 of the server apparatus 200. (3) The controller 310 executes a classification process and displays second teaching material information on a teaching material having been used more than a predetermined level (e.g., teaching material used by 3000 users).

As a seventh modification example, input of character information in Activity A330 is not limited to input reception by the input receiving unit 340, but the character information may be input by copying and pasting character information from, for example, a digital textbook or the like. In this case, the copied-and-pasted character information is acquired as a teaching material in Activity A340.

As an eighth modification example, a receiving unit 319 may be further provided. The receiving unit 319 may receive a selection operation with respect to an arbitrary character in a character of a teaching material (first character information). In this case, the conversion unit 313 converts the selected character into sound information.

In the eighth modification example, in a case where the information processing apparatus 300 is a smartphone or a tablet terminal, when an arbitrary character in the teaching material displayed on a display screen is traced (a selection operation is performed) with a finger, sound of the character corresponding to the traced part is output from the speaker 380. Specifically, for example, when the word “light” in the teaching material is traced with a finger, the sound of “light” is output from the speaker 380.

In the eighth modification example, for example, the following four steps of information processing are performed. (1) The controller 310 receives a selection operation with respect to an arbitrary character in a character of a teaching material. (2) The controller 310 reads a known conversion program stored in the storage unit 320. (3) The controller 310 executes a conversion process of converting the selected character into sound information. (4) The controller 310 allows the sound information to be output from the speaker 380.

As a ninth modification example, when there is a different character that is a character having not been determined to be the matching point, the display control unit 315 may display a word unit including the different character in the first character information in a same display manner as a display manner of the first character information.

As a tenth modification example, the display control unit 315 may display a newly determined matching point while maintaining the display of the already displayed matching points.

The present disclosure may be provided in each of the following forms.
(1) An information processing method comprising: a reading step of reading first character information on a character of a teaching material; an acquisition step of acquiring a read-aloud sound relating to a first user's voice when the first user reads aloud the first character information; a conversion step of converting the read-aloud sound into second character information on a character; a determination step of determining, based on the first character information and the second character information, a matching point between the first character information and the second character information; and a display control step of, when there is the matching point, displaying the matching point in the first character information in a different display manner from a display manner of the first character information.
(2) The information processing method according to (1), wherein in the display control step, the matching point is displayed in at least one display manner of (a) a highlighted display, (b) an emphasized-character display, and (c) a display using a font different from a font of the first character information.
(3) The information processing method according to (1) or (2), wherein in the acquisition step, a captured image is acquired as the teaching material.
(4) The information processing method according to any one of (1) to (3), wherein in the acquisition step, input sound information is acquired as the teaching material.
(5) The information processing method according to any one of (1) to (4), wherein in the acquisition step, input character information is acquired as the teaching material.
(6) The information processing method according to any one of (1) to (5), further comprising a memory control step of storing number of the matching point.
(7) The information processing method according to any one of (1) to (6), wherein in the acquisition step, progress information is acquired, the progress information being information on progress in reading aloud of a second user different from the first user.
(8) The information processing method according to (7), wherein in the display control step, first teaching material information on a teaching material used by the second user with more than a predetermined level of progress is displayed.
(9) The information processing method according to any one of (1) to (8), further comprising a transmitting-receiving step of transmitting and receiving a message between the first user and a second user different from the first user.
(10) The information processing method according to any one of (1) to (9), further comprising a transmitting-receiving step of transmitting and receiving the teaching material between the first user and a second user different from the first user.
(11) The information processing method according to any one of (1) to (10), wherein: in the conversion step, the first character information is converted into sound information, and in the display control step, a corresponding point is displayed in a display manner different from the display manner of the first character information, the corresponding point corresponding to the sound information that has been output.
(12) The information processing method according to (11), further comprising a receiving step of receiving a selection operation with respect to an arbitrary character in the first character information, wherein in the conversion step, the selected character is converted into sound information.
(13) The information processing method according to (11) or (12), wherein in the display control step, the corresponding point is displayed in at least one display manner of (a) a highlighted display, (b) an emphasized-character display, and (c) a display using a font different from a font of the first character information.
(14) The information processing method according to any one of (1) to (13), further comprising a correction step, wherein: in the determination step, at least one of spelling and grammar of the first character information is determined to be correct or incorrect, and in the correction step, a point determined to be incorrect in the first character information is corrected.
(15) The information processing method according to any one of (1) to (14), wherein: in the acquisition step, usage of the teaching material is acquired, and in the display control step, second teaching material information is displayed, the second teaching material information being information on a teaching material that has been used more than a predetermined level.
(16) A non-transitory computer-readable memory medium storing a program that allows a computer to execute each step of the information processing method according to any one of (1) to (15).
(17) An information processing apparatus comprising a processor configured to execute a program so as to execute each step of the information processing method according to any one of claims (1) to (15).

The present disclosure is not these.

1. An information processing method comprising:
a reading step of reading first character information on a character of a teaching material;
an acquisition step of acquiring a read-aloud sound relating to a first user's voice when the first user reads aloud the first character information;
a conversion step of converting the read-aloud sound into second character information on a character;
a determination step of determining, based on the first character information and the second character information, a matching point between the first character information and the second character information, wherein the matching point is determined by a word unit; and
a display control step of:
when there is the matching point, displaying the matching point in the first character information in a different display manner from a display manner of the first character information,
when there is a different character that is a character having not been determined to be the matching point, displaying a word unit including the different character in the first character information in a same display manner as the display manner of the first character information, and
when there is a newly determined matching point, displaying the newly determined matching point while maintaining a display of the already displayed matching point.

2. The information processing method according to claim 1,
wherein in the display control step, the matching point is displayed in at least one display manner of (a) a highlighted display, (b) an emphasized-character display, and (c) a display using a font different from a font of the first character information.

3. The information processing method according to claim 1,
wherein in the acquisition step, a captured image is acquired as the teaching material.

4. The information processing method according to claim 1,
wherein in the acquisition step, input sound information is acquired as the teaching material.

5. The information processing method according to claim 1,
wherein in the acquisition step, input character information is acquired as the teaching material.

6. The information processing method according to claim 1, further comprising a memory control step of storing number of the matching point.

7. The information processing method according to claim 1,
wherein in the acquisition step, progress information is acquired, the progress information being information on progress in reading aloud of a second user different from the first user.

8. The information processing method according to claim 7,
wherein in the display control step, first teaching material information on a teaching material used by the second user with more than a predetermined level of progress is displayed.

9. The information processing method according to claim 1, further comprising a transmitting-receiving step of transmitting and receiving a message between the first user and a second user different from the first user.

10. The information processing method according to claim 1, further comprising a transmitting-receiving step of transmitting and receiving the teaching material between the first user and a second user different from the first user.

11. The information processing method according to claim 1, wherein:
in the conversion step, the first character information is converted into sound information, and
in the display control step, a corresponding point is displayed in a display manner different from the display manner of the first character information, the corresponding point corresponding to the sound information that has been output.

12. The information processing method according to claim 11, further comprising a receiving step of receiving a selection operation with respect to an arbitrary character in the first character information,
wherein in the conversion step, the selected character is converted into sound information.

13. The information processing method according to claim 11,
wherein in the display control step, the corresponding point is displayed in at least one display manner of (a) a highlighted display, (b) an emphasized-character display, and (c) a display using a font different from a font of the first character information.

14. The information processing method according to claim 1, further comprising a correction step, wherein:
in the determination step, at least one of spelling and grammar of the first character information is determined to be correct or incorrect, and
in the correction step, a point determined to be incorrect in the first character information is corrected.

15. The information processing method according to claim 1, wherein:
in the acquisition step, usage of the teaching material is acquired, and
in the display control step, second teaching material information is displayed, the second teaching material information being information on a teaching material that has been used more than a predetermined level.

16. A non-transitory computer-readable memory medium program that allows a computer to execute each step of the information processing method according to claim 1.

17. An information processing apparatus comprising a processor configured to execute a program so as to execute each step of the information processing method according to claim 1.
